(19) United States
(12) Patent Application Publication
(10) Pub. No.: US 2006/0111985 A1
(43) Pub. Date: May 25, 2006

(54) Systems, methods and apparatus for content storage, auction and management

(75) Inventors: Andrew K. Sheldon, Redwood City, CA (US); David L. de Heer, Woodside, CA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 10/997,238

(22) Filed: Nov. 24, 2004

(51) Int. Cl. G06Q 30/00

(52) U.S. Cl. 705/26

(57) ABSTRACT

Systems, methods, and apparatus for content storage, auction, and management is described. In an implementation, a method includes auctioning storage space on a client as available, for purchase, to a plurality of potential purchasers. Purchasing information received form the plurality of potential purchasers is processed to determine which of the potential purchasers, if any, is permitted to store content in the storage space on the client.

### TECHNICAL FIELD

The present invention generally relates to the field of content and more particularly relates to systems, methods, and apparatus for content storage, auction, and management.

### BACKGROUND

Users have access to devices that have an ever increasing range of functionality to playback content at a client device. One such example is digital video recorder (DVR) functionality. For instance, a DVR may include a hard disk memory. Due to the size of the memory, users of the DVR are able to record content. DVRs also offer “trick modes”, such as the ability to pause content that is currently being broadcast and allows users to watch the content, while still in progress, from the point it was paused. For example, the DVR may play back the content from disk memory, starting at the pause event, while continuing to record the currently-broadcast content in the disk memory. Additionally, the DVR may support other trick modes, such as rewinding, fast forwarding, slow motion playback, and the like.

Even though the memory on the DVR may be utilized to record a large amount of content, the DVR may still include unused storage space. The unused storage space may be available for a variety of reasons. For instance, a provider of the DVR may retain a portion of the storage device to push content to the storage device as desired by the provider, such as to provide locally stored video-on-demand (VOD) which is available for purchase by the user of the DVR. In another instance, the DVR may include storage space in the memory that is not currently being used to store television programs. Therefore, there is an opportunity for use of this unused storage space that is available on the client devices to provide additional functionality to client devices and content providers.

### SUMMARY

Systems, methods, and apparatus for content storage, auction, and management are described. In an implementation, unused storage space that is available on the plurality of client devices is monitored and maintained by a head end such that the head end is “aware” of the amount of available storage space on the client devices. For instance, the storage space may be “set aside” by a provider (e.g., manufacturer, network operator, and so on) of the client devices (e.g., DVRs) such that the head end is aware of the amount of storage space that is set aside. In another instance, the head end is aware of how much storage space is not currently being utilized by each of the client devices, such as by monitoring (e.g., polling) the client devices, receiving a communication from the client devices, and so on.

The head end may then expose this available storage space for purchase to a plurality of potential purchasers. This storage space may be utilized to provide a wide variety of functionality, such as to push video on demand (VOD) content for local storage on the client devices, for local storage of advertisements on the client devices, and so on. For example, the head end may auction the storage space to the plurality of potential purchasers for bidding. Based on the bidding, the head end may determine which of the potential purchasers has “won” the right to content on the plurality of client devices and cause the content to be stored on the client devices. Thus, the content is locally obtainable by the respective client devices.

Local storage of content may provide a variety of additional functionality. For example, the head end may receive unexpected content, such as overtime in a sporting event. Due to the high likelihood that users will wish to view the sporting event, the unexpected content item may be viewed by a vast number of viewers and therefore provide a large potential audience. The head end may offer an opportunity to output one or more of the locally-stored content (e.g., advertisements) in conjunction with the unexpected content, such as by again providing an auction to those potential purchasers which previously stored content on the client devices. Thus, the advertisements may be output to a large potential audience for a payment amount that may accurately reflect the magnitude of the opportunity. Although DVRs have been described, a wide variety of client devices and systems may employ similar functionality without departing from the spirit and scope thereof, such as network enabled computers, wireless phones, and so forth.

### BRIEF DESCRIPTION OF THE DRAWINGS

FIG. 1 is an illustration of an exemplary environment configured to auction available memory storage space that is located on client devices.

FIG. 2 is an illustration of a system in an exemplary implementation that is operable to provide the environment of FIG. 1.

FIG. 3 is a flow diagram depicting a procedure in an exemplary implementation in which storage space that is available on a client is exposed for purchase to a plurality of potential purchasers.

FIG. 4 is a flow diagram depicting a procedure in an exemplary implementation in which an occurrence of a content output event triggers an opportunity to purchase a right to output an advertisement that was locally stored on the client via the procedure of FIG. 3.

FIG. 5 is a flow diagram depicting a procedure in an exemplary implementation in which storage space that is available on a plurality of client devices is auctioned to a plurality of potential purchasers for storage of advertisements on the client devices.

FIG. 6 is a flow diagram depicting a procedure in an exemplary implementation in which an auction is utilized to offer an opportunity to a plurality of potential purchasers to output advertisements stored on the plurality of client devices via the procedure of FIG. 5.

FIG. 7 is a flow diagram depicting a procedure in an exemplary implementation in which a content item is reassessed for a change in an advertising fee.

The same reference numbers are utilized in instances in the discussion to reference like structures and components.

### DETAILED DESCRIPTION

Overview

Systems, methods, and apparatus for content storage, auction, and management are described. In an implementation, a system is described which facilitates auctioning of local storage space on client devices. For instance, an operator (e.g., a cable provider), having reserved some hard drive space for other business arrangements, might have some capacity left over on each digital video recorder (DVR). The operator may auction the space to the highest bidder for local storage of content. This auctioning may support a variety of business models, such as a “pay for space” on each of the client devices, “percentage of revenue for pay to play”, and so on. For example, content owners may access an online auction via a web browser and enter a bid. Successful bidders may then use the system to push content to the client devices, such as to push advertisements and other content items for local storage on the client. Another auction may also be provided for output of the locally-stored content items, such as advertisements in conjunction with an unexpected content event (e.g., overtime in a sporting event), an opportunity to output locally stored video, and so on.

A classic problem in traditional advertising is due the occurrence of unexpected content items (e.g., extra innings in a baseball game), which are typically not pre-sold by advertising sales departments. However, extra innings in a baseball game may imply a close game and consequently an increased interest level by viewers of the game and a larger audience. Thus, the advertising inventory in this unexpected content item may a corresponding increased value to advertisers. By providing an opportunity to output advertisements in conjunction with the unexpected content item, the auction system may provide additional advertising opportunities that benefit both advertisers and operators.

The auction system may also be configured to provide reporting services such that potential purchasers may make an informed determination of the value of the opportunity that is being offered for purchase. For example, the advertising industry, in general, may desire a move toward a more accountable format, in that the advertising opportunity being purchased may accurately reflect the exposure to potential consumers. Therefore, the auction system may employ a reporting system which describes the number of current viewers of a content item, demographics of the viewers, and so on, and then offer an opportunity, for purchase, to output an advertisement in conjunction with the content item. In the following discussion, exemplary environments and systems will first be discussed which are operable to implement content storage, auction, and management techniques. This discussion will then be followed by exemplary procedures which may be implemented in the described environments and systems.

Exemplary Environment

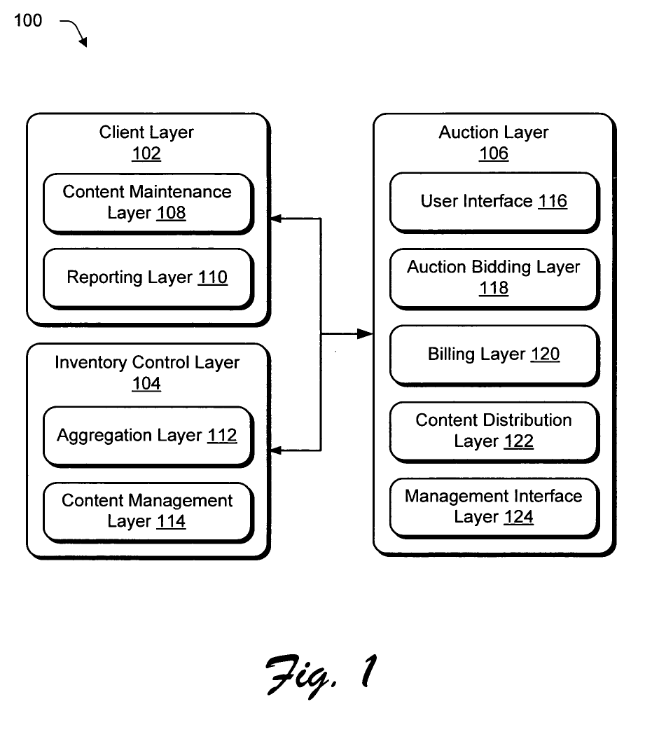

FIG. 1 is an illustration of an exemplary “client device space auction” environment 100 configured to auction available memory storage space that is located on client devices. In the illustrated implementation, the “client device space auction” environment 100 (hereinafter “environment”) includes three layered software systems, a client layer 102, an inventory control layer 104, and an auction layer 106 which are communicatively coupled, one to another.

The client layer 102 may serve a variety of functions. For example, the client layer 102 may include a content maintenance layer 108, which is a sub-layer of the client layer 102 and is executable to maintain and update assets (i.e., content items) on a client device, such as subscriber-selected video assets, push content, and advertising. The client layer 102 may output these assets based on a variety of considerations, such as subscriber input and business rules. The client layer 102 may also be configured to report what assets, if any, are currently stored on a respective client device through execution of an included reporting layer 110. For instance, the reporting layer 110 may be executable to form a communication for transmission to the inventory control layer 104 such that the inventory control 104 may track the amount of available memory storage space.

The inventory control layer 104 may be managed by an operator of a network system, such as a cable provider and so on. Like the client layer 102, the inventory control layer 104 also has a variety of responsibilities. For example, the inventory control layer 104 may expose available memory storage space reported from the client layer 102 to the auction layer 106, may accept assets (i.e., content) from the auction layer 106 for communication to the client layer 102, and so on. In another example, the inventory control layer 104 aggregates asset reports from the client layer 102 through execution of an aggregation layer 112. For instance, the inventory control layer 104 may accept a plurality of reports from a plurality of client layers (and their respective reporting layers) and aggregate these reports for communication to the auction layer 106. The aggregated reports may be utilized to notify potential purchasers of the available storage space and the number of client devices having the available storage space. The aggregation layer 112 may also be executed to supply demographics of the clients, such as user preferences and so on. In a further example, the inventory control layer 104 includes a content management layer 114 that is responsible for managing content storage on client devices. For instance, the content management layer 114 may “age out” pushed assets based on business rules, and so on. For instance, upon the expiration of a business relationship (e.g., a contract) with a particular content provider, the content management layer 114 may cause corresponding content that is stored locally on the clients to be removed.

The auction layer 106 of FIG. 1, as illustrated, has five sub-layers of functionality. First, the auction layer 106 provides a web-based user interface 116 that allows potential purchasers to view and bid on available storage space. For example, the inventory may be exposed on a profiled, targeted basis, such that potential purchasers can buy space based on household demographics, psychographics, and geography. For instance, the user interface 116 may collect the aggregated reports from the aggregation layer and expose all or a portion of these reports to prospective purchasers.

The auction layer 106 also provides for the execution of the auctions through an auction bidding layer 118. The auction bidding layer 118, for instance, may provide time-limited auctions, sealed-bid Dutch auctions, and so on. Bidders (i.e., potential purchasers) may log into the auction layer 106, such as by presenting their credentials for authentication as part of the log-in through the web-based user interface 116. If the bidder is authenticated, the bidder may then place bids on available inventory lots, i.e., portion of memory on the client devices. Once the bid is placed, the auction bidding layer 118 may be executed to periodically inform the bidder on the progress of the auction (for timed auctions), on the final disposition of a bid when the auction is completed, and so on.

The auction layer 106 also includes billing layer 120, which is executable to provide billing, reporting, and reconciliation. For example, once a bidder has successfully bid on a part of the disk inventory of a digital video recorder (DVR), the bidder is billed for the disk space that's delivered, i.e., made available to the bidder for local storage of content. The bidder may receive an aggregated usage report from the billing layer 120 to document a return on investment (ROI) for the purchase.

Further, the auction layer 106 includes a content distribution layer 122, which is executable for content (i.e., asset) ingestion and distribution. For example, as previously described, successful bidders are allowed to enter content for the inventory blocks (e.g., portions of disk memory of a DVR) that have been purchased. This inventory may be passed together with metadata that describes business rules (i.e., time windows, reporting rules, and the description of the inventory purchased including target profiles) to the inventory control layer 104 for distribution and management.

The auction layer 108 also includes a management interface layer 124 that allows an operator to set-up auction rules, manage and authenticate bidders, provide and revoke credentials, control access to inventory, and so on. Further discussion of these layers may be found in relation to the following exemplary system.

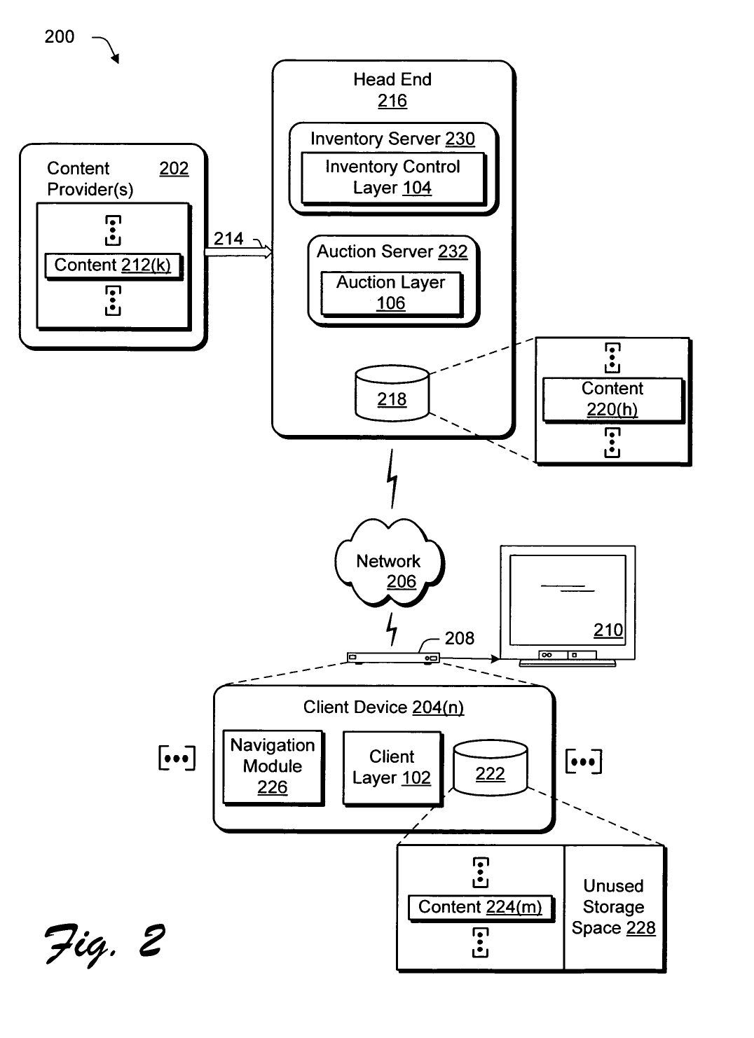

FIG. 2 is an illustration of a system 200 in an exemplary implementation that is operable to provide the environment 100 of FIG. 1. The system 200 includes a content provider 202 which is communicatively coupled to a plurality of client devices 204(n), where “n” can be any integer from one to “N”, over a network 206. The client devices 204(n) may be configured in a variety of ways. For example, one or more of the client devices 104(n) may be configured as a computer that is capable of communicating over the network 206, such as a desktop computer, a game console, a mobile station, an entertainment appliance, a set-top box 208 communicatively coupled to a display device 210 as illustrated, a wireless phone, and so forth. The client devices 204(n) may range from full resource devices with substantial memory and processor resources (e.g., television enabled personal computers, television recorders equipped with hard disk) to low-resource devices with limited memory and/or processing resources (e.g., traditional set-top boxes). The network 206 is illustrated as the Internet, and may include a variety and combinations of other networks, such as an intranet, a wired or wireless telephone network, a broadcast network with a backchannel to provide two-way communication, and so forth.

The content provider 202 includes a plurality of content 212(k), where “k” can be any integer from 1 to “K”. The content 212(k) may include a variety of data, such as television programming, video-on-demand (VOD), one or more results of remote application processing, and so on. The content 212(k) is communicated over a network 214 to a head end 216. The network 214 may be the same as or different from network 206.

Content 212(k) communicated over the network 214 is received by the head end 216 and stored in a storage device 218 as content 220(h), where “h” can be any integer from “1” to “H”. The content 220(h) may be the same as or different from the content 212(k) received from the content provider 202. The content 220(h), for instance, may include additional data for broadcast to the client 204(n). For example, as previously described, the content 220(h) stored in the storage device 218 may include advertisements, video on demand content for local storage on the client device 204(n), and so on. Distribution from the head end 216 to the client device 204(n) may be accommodated in a number of ways, including cable, RF, microwave, digital subscriber line (DSL), and satellite.

The client device 204(n) may be configured in a variety of ways to receive the content 220(h) from over the network 206. As illustrated, the client device 204(n) may be configured as a set-top box 208 that is communicatively coupled to the display device 210. As previously described, the client device 204(n) may also be configured as a wireless phone, a game console, a broadcast-enabled computer, an information appliance, and so on. Although a display device 210 is shown, a variety of other output devices are also contemplated, such as speakers.

The client device 204(n) may also include digital video recorder (DVR) functionality. For instance, the client device 204(n) may include a storage device 222 to record content 220(h) received from the network 206 for output to and rendering by the display device 210. The storage device 222 may be configured in a variety of ways, such as a hard disk drive, a removable computer-readable medium (e.g., a writable digital video disc), and so on. Content 224(m), where “m” can be any number from “1” to “M”, that is stored in the storage device 222 of the client 204(n) may include copies of the content 220(h) that was streamed from the head end 216.

The client device 204(n) includes a navigation module 226 that is executable on the client device 204(n) to control content playback on the client 204(n), such as through the use of one or more “trick modes”. Trick modes may provide non-linear playback of the content 224(m) (i.e., time shift the playback of the content 124(m)) such as pause, rewind, fast forward, slow motion playback, and the like. For example, during a pause, the client device 204(n) may continue to record the content 220(h) in the storage device 222 as content 224(m). The client device 204(n), through execution of the navigation module 226, may then playback the content 224(m) from the storage device 222, starting at the point in time the content 224(m) was paused, while continuing to record the currently-broadcast content 220(h) in the storage device 222 from the head end 216. Thus, the client device 204(n), through use of the storage device 222, may provide DVR functionality.

As previously described, even though the storage device 222 may be utilized to record a large amount of content 224(m), the storage device 222 may still include unused storage space 228. The unused storage space 228 may be available for a variety of reasons. For instance, a manufacturer and/or provider of the client device 204(n) (e.g., a cable television provider) may retain a portion of the storage device 222 as available for the head end 216 to push content 220(h), such as to provide locally stored video-on-demand (VOD), advertisements, and so on as previously described. In another instance, the unused storage space 228 is a portion of the storage device 222 that is not currently being used to store the content 224(m).

To manage the unused storage space 228, the head end 116 includes an inventory control layer 104 which is executable on an inventory server 230 to manage the unused storage space 228 on each of the client devices 204(n). For example, the inventory control layer 104 may be executed to expose the unused storage space 228 as available for purchase to the content provider 102 over the network 106 as previously described in FIG. 1. For example, the content provider 102 may purchase one or more portions of the unused storage space 228 for storing items of content 112(k) (i.e., “content items”). Although a single content provider 202 is illustrated, the unused storage space 228 may be exposed to a plurality of content providers for purchase.

Upon purchase of the one or more portions, the content 112(k) may be communicated directly to the client device 204(n) for storage in the previously unused storage space 228 of the storage device 222. In another implementation, the content 112(k) is first communicated to the head end 216 for subsequent communication to the client device 204(n) by the inventory control layer 104 as previously described. For example, the inventory control layer 104 may be executed to push the content 220(h) to the client device 104(n) for storing on the storage device 222.

In the illustrated environment 200, the auction layer 106 is executed on an auction server 232. Although illustrated separately, the auction layer 106 and the inventory control layer 104 may also be implemented together on a server, server cluster, and so on. The auction layer 106, when executed, may provide a user interface 116 of FIG. 1 to the content provider 202 for auctioning the unused storage space 228 of the client device 204(n). The auction layer 106 may also be executed to auction an opportunity to output content 224(m) stored on the client device 204(n). For example, the content 224(m) may include an advertisement. Due to an unexpected event in the output of a content item (e.g., overtime in a sporting event), the auction layer 106 may be executed to auction an opportunity to output the advertisement that is stored on the client device 204(n). Thus, the auction may provide a “last minute” opportunity to output advertisements in conjunction with a content item that may have a larger audience than originally expected. Further discussion of the output of content may be found in relation to the exemplary procedures in the following section.

Generally, any of the functions described herein can be implemented using software, firmware, fixed logic circuitry, manual processing, or a combination of these implementations. The terms “layer”, “module,” “functionality,” and “logic” as used herein generally represent software, firmware, or a combination of software and firmware. In the case of a software implementation, the layer, module, functionality, or logic represents program code that performs specified tasks when executed on a processor (e.g., CPU or CPUs). The program code can be stored in one or more computer readable memory devices for execution on a processor. The features of the distribution, storage, and purchasing strategies described below are platform-independent, meaning that the strategies may be implemented on a variety of commercial computing platforms having a variety of processors.

Exemplary Procedures

The following discussion describes distribution, storage, purchase and output techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks.

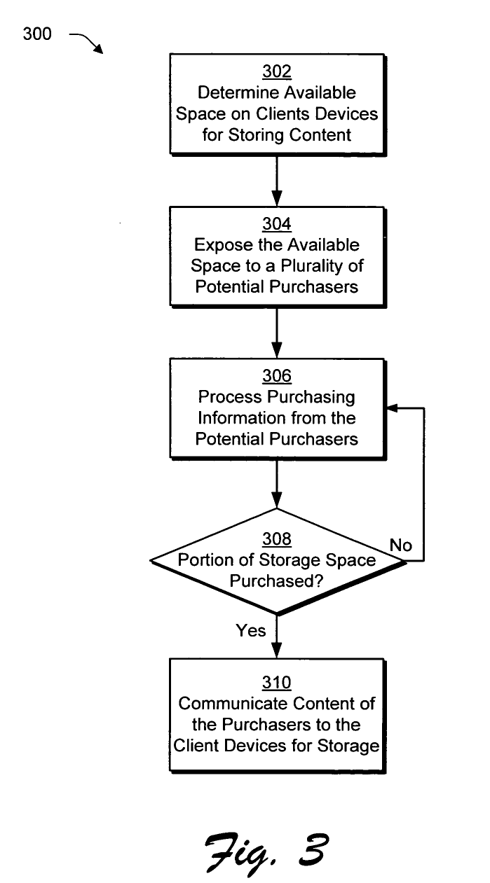

FIG. 3 is a flow diagram depicting a procedure 300 in an exemplary implementation in which storage space that is available on a client is exposed for purchase to a plurality of potential purchasers. First, the available storage space on a client device is determined (block 302). For example, the inventory control layer 104 of FIG. 2 may receive a report from the client layer 102 which describes the amount of available space on the client device 204(n). In another example, the inventory control layer 104 of FIG. 1 may be executed to inspect the client device 204(n) to determine the amount of storage space on the client 104(n), if any, which is not currently being utilized to store content 124(m). Based on this determination, the inventory control layer may then compute the amount of storage space that is available to store content. For instance, the inventory control layer 104 of FIG. 2 may determine that a portion of the storage space on the storage device 222 should remain for continued storage of content 124(m) by a user of the client device 204(n). Therefore, the computed amount of available storage space for storing content does not include this portion. In another example, the inventory control layer determines the amount of space in the storage device which is “set-aside” by the manufacturer/provider of the client device 204(n) of FIG. 2 and what content, if any, is already stored in the storage device 222.

The available storage space in the storage device is then exposed for purchase to a plurality of potential purchasers (block 304). The exposure of the available storage space may be accomplished in a variety of ways. For example, the auction module 106 of FIG. 2 may be executed to notify each of a plurality of potential purchasers (e.g., content providers 202) via a web site of the availability of the storage space. In another example, the auction module sends a communication (e.g., an email, an instant message, and so on) to each potential purchaser that includes the amount of available storage space and a price per portion of the potential storage space.

After the exposure of the storage space (block 304), purchasing information that is obtained from the plurality of purchasers (block 306) is processed. For example, the billing layer 118 of FIG. 1 may be executed to receive and process billing information. A determination is then made as to whether a portion of the storage space has been purchased by one or more of the potential purchasers (decision block 308). For example, the auction billing layer may determine that although a request has been received from a specific potential purchaser, that specific potential purchaser does not have available funds, is not permitted to store advertisement on the DVR (e.g., the content provider proposes an advertisement that does not comply with the preferences of the client, such as advertisements for particular vices), and so on. Therefore, the billing layer may return to processing purchase information from other potential purchasers (block 306).

If the available storage space has been successfully purchased (decision block 308), content from the successful purchaser is communicated to the client for storage on the storage device (block 310). The content in this exemplary procedure 300 may take a variety of forms. For example, the content may be configured as a VOD for local storage on the client device, a game for purchase by a user of the client device, an advertisement, and so on. For instance, the content 220(h) of FIG. 2 may include content that was previously communicated from the content provider 202. The inventory server 230 may therefore communicate the content across the network 106 for storage in the storage device 222 of the client device 204(n). In another implementation, the inventory control layer 104 provides a certificate to the successful purchaser, which may then be communicated with content from the successful purchaser to the client device for authentication by the client layer 102. Thus, based on the certificate, the client layer 102 may determine whether the storage of content from that particular provider is permitted on the client device 204(n), thereby protecting against attack from malicious parties.

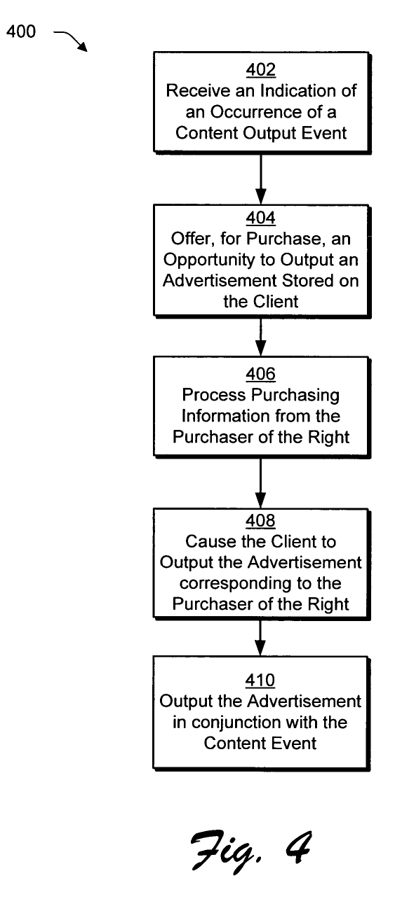

FIG. 4 is a flow diagram depicting a procedure 400 in an exemplary implementation in which an occurrence of a content output event triggers an opportunity to purchase a right to output an advertisement that was locally stored on the client via the procedure 300 of FIG. 3. An indication of a content output event is received (block 402). For example, the head end 216 of FIG. 2 may receive an unexpected content item from the content provider 202. The content item may be determined as unexpected in a variety of ways. For example, the content item may have a flag which indicates that the content item was not previously scheduled for output.

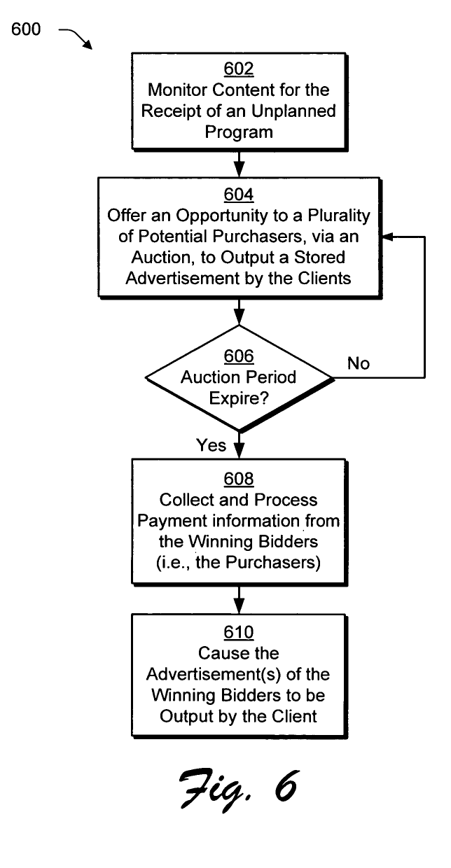

Upon receipt of the indication, an offer is made to purchase an opportunity to output an advertisement that is stored on the client (block 404). Like the exposing (block 304 of FIG. 3) that was previously described, the offer may be made in a variety of ways. For example, a plurality of potential purchasers may be notified via a web site of the occurrence of the content output event. In another example, a communication is sent to each potential purchaser that indicates the occurrence of the event and an opportunity to output an advertisement in conjunction with the event. In a further example, the availability of the opportunity to output an advertisement in conjunction with the unexpected content item is exposed via an auction, further discussion of which may be found in relation to FIG. 6.

Purchasing information received in response to the offer is then processed (block 406). For example, the auction layer 106 of FIG. 1 may communicate with a financial institution over a network to transfer funds from the potential purchaser to a provider of the opportunity (e.g., a network operator which operates the head end 216 of FIG. 2). In another example, the auction layer 106 of FIG. 1 (and more particularly the billing layer 120) obtains identifying information which is sufficient to bill the purchaser at a later

The auction layer 106 then communicates with the inventory control layer 104 of FIG. 2 to cause the client device 204(n) to output the advertisement as desired by the purchaser (block 408). For example, the inventory control layer 104 of FIG. 2 may communicate a message to the client device 204(n) that identifies a particular one of the content 224(m) items (e.g., the advertisement) stored in the storage device 222 and when to output the content 224(m) items. The message may include verification information, such as a certificate from a third-party verifying authority. The message may be communicated in a variety of ways, such as streamed in conjunction with content 220(h) of FIG. 2 over the network 206 to the client device 204(n).

The output of the particular advertisement may be performed in a variety of ways. For instance, continuing with the previous example, the selected advertisement may be output in conjunction with the unexpected content item (block 410). Therefore, the selected advertisement may be output to a large potential audience that may wish to view the unexpected content item. During a playoff following a regularly scheduled golf event, for instance, the advertisement may be output while the golfers transition between holes. Because more viewers are likely to tune into the playoff than watch the entire golf event, the advertisement may be output to a larger potential audience. In another example, the unexpected content item (e.g., a live feed of a breaking news event) may replace a rerun of a television program, and thus have a greater potential audience.

The procedures 300, 400 as described, respectively, in relation to FIGS. 3 and 4 describe a wide variety of purchasing techniques for exposing available of storage space and for causing the stored content to be output by the client devices. In the following procedures, use of an auction purchasing technique is described in greater detail.

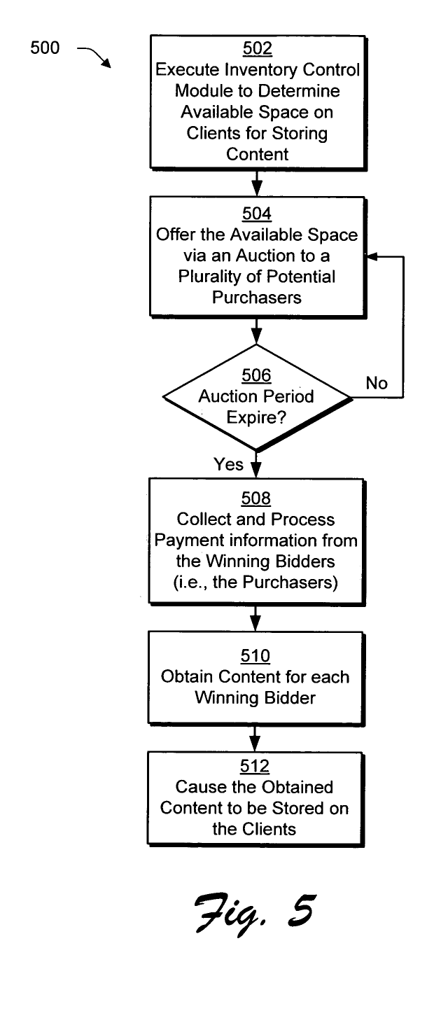

FIG. 5 is a flow diagram depicting a procedure 500 in an exemplary implementation in which storage space that is available on a plurality of client devices is auctioned to a plurality of potential purchasers for storage of content on the client devices. An inventory control module is executed to determine available space on a plurality of client devices for storing content (block 502). As previously described, the determination may be made in a variety of ways. For example, the inventory control module may poll each client device, may examine each client device, may track content storage on the plurality of client devices, may receive reports from each client device, and so on.

The available storage space is then offered via an auction to a plurality of potential purchasers (block 504). For example, the auction layer may provide an auction web site that describes the availability of the storage space. The auction web site may be provided utilizing a variety of techniques. For example, the auction web site may provide a “sealed-bid” type auction in which only one bid is allowed from each potential purchaser, with the highest sealed-bid “winning” the auction. In another example, a “Dutch” auction may be utilized. The Dutch auction is named a system used for buying and selling flowers in Holland, and is commonly used to sell securities (e.g., treasury bonds). In a Dutch auction, a seller typically seeks bids within a specified price range. After evaluating the range of bid prices received, the seller accepts the lowest price that will allow the seller to dispose of the entire block.

In a further example, a highest-bidder auction may be provided in which bidders are allowed to submit multiple bids during a predetermined period of time, which may be referred to as the “auction period”. Once the auction period has expired (decision block 506), the auction layer of FIG. 1 may collect and process payment information from the winning bidders (e.g., via the billing layer 120), such as the potential purchasers which supplied a winning bid (block 508). For example, the auction may provide portions of the available storage space on each of the client devices, with the winning bidders being the potential purchasers which supplied the highest bids.

The auction layer may then communicate with the inventory control layer to indicate the winning bidders. The inventory control layer, upon receipt of the communication, may then obtain content from each winning bidder (block 510). For example, the inventory control layer 104 of FIG. 2 may send a communication to each winning bidder (e.g., content provider 202) that requests communication of a desired content item for storage on the client devices. In another example, the inventory control layer verifies content items received from each of the purchasers with the information received from the auction layer.

The inventory control layer may then be executed to cause the obtained content items to be stored on the client devices (block 512). For example, the inventory control layer may form a communication for each of a plurality of client devices, the communications including the advertisements. The advertisements may be communicated in a variety of ways, such as streamed from the head end 216 with content 220(h) of FIG. 2, broadcast via a carousel file system, and so on. Thus, after procedure 500 has been performed, each of the plurality of client devices 104(n) includes locally stored content item(s) in the previously unused storage space 228. As previously described, a variety of other content may be stored on the client devices as a result of an auction, such as VOD, applications, games, music, advertisements, and so on.

FIG. 6 is a flow diagram depicting a procedure 600 in an exemplary implementation in which an auction is utilized to offer an opportunity to a plurality of potential purchasers to output advertisements stored on the plurality of client devices via the procedure 500 of FIG. 5. In this example, broadcast content is monitored for receipt of an unplanned program (block 602). For example, the head end 216 of FIG. 2 (and more particularly the auction layer) may monitor content 212(k) received from the content provider 202 to determine if a television program included in the content 212(k) is planned.

Upon receipt of an unplanned program, an opportunity is offered via an auction to a plurality of potential purchasers to output an advertisement stored on a plurality of client devices (block 604). For example, the head end may email each of a plurality of potential purchasers regarding the occurrence of the unplanned program, the content of the unplanned program, and an estimated number of client devices which will output the unplanned program. The email may reference an auction website, at which, an opportunity to output a previously stored advertisement will be offered via an auction. The potential purchasers may then interact with the auction website to bid on the opportunity as previously described. In an implementation, the bidding is allowed to occur for a predetermined amount of time. For example, the head end may determine when each opportunity to output an advertisement in conjunction with the unexpected content item is to occur. Therefore, the head end may provide a plurality of auctions for each of the opportunities, each having an auction period that is set to enable sufficient time to determine a winner of the auction and cause an advertisement of the winning bidder to be output by the plurality of client devices.

In this implementation, a determination is made as to whether the auction period has expired (decision block 606). If so, the head end (and more particularly the auction layer) collects and processes payment information from the winning bidders, i.e., the purchasers of the opportunity (block 608). The head end then causes the advertisements of the winning bidders to be output by the client (block 610), such as through communication of the auction layer 106 with the inventory control layer 104 of FIG. 2. For instance, the unexpected content item may include commercial breaks, and therefore the head end may communicate a message to the plurality of client devices which cause the advertisements which are stored locally on the client devices to be output during the commercial breaks. In another instance, an operator of the head end may make a determination of when to output the stored advertisements. For example, the head end may receive a live feed of a breaking news event that does not include preconfigured commercial breaks. Therefore, an operator of the head end may determine when, during the live feed, to output advertisements by the plurality of client devices. Although the procedures 500 and 600 of FIGS. 5 and 6, respectively, were described as being performed by the head end, a wide variety and collections of devices may be utilized to perform the described actions.

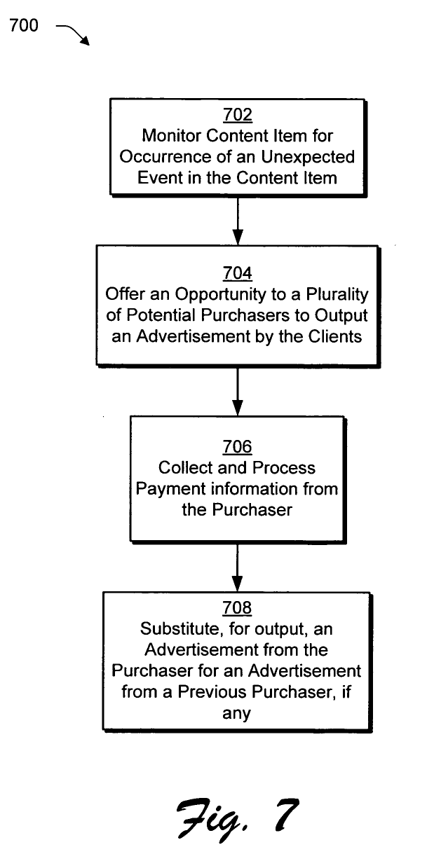

FIG. 7 is a flow diagram depicting a procedure 700 in an exemplary implementation in which a content item is reassessed for a change in an advertising fee. In the previous implementations, an unexpected content item (e.g., a breaking news event) that was different from an expected content item (e.g., a rerun of a television program) was described. An unexpected content item may also include an unexpected change to an expected content item, such as a close score in the last quarter of a football game, a tenth episode of a television program that unexpectedly has higher viewership than previously expected, and so on. To address this unexpected change, the unexpected content item may be dynamically reassessed for different advertising costs and then substitute advertisements from purchasers for advertisements from previous purchasers that were to be output in conjunction with the content item.

A module, for example, may be executed to monitor a content item for an occurrence of an unexpected event in the content item (block 702). For example, the unexpected event may occur during the output of the content item (e.g., a close football game in the fourth quarter) and/or before the output of the content item (e.g., an unexpected rise in viewership of a previous episode). When the unexpected event has occurred, an opportunity is offered to a plurality of potential purchasers to output an advertisement by the client devices (block 704). For example, the opportunity may be provided as an auction as previously described.

Payment information may then be collected and processed from the purchaser (block 706). An advertisement from the purchaser is substituted, for output, for an advertisement from a previous purchaser, if any (block 708). In this way, the payment collected for the substituted advertisement may accurately reflect the change in viewership caused by the occurrence of the unexpected event.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
auctioning storage space on a client as available, for purchase, to a plurality of potential purchasers; and
processing purchasing information received from the plurality of potential purchasers to determine which said potential purchaser, if any, is permitted to store content in the storage space on the client.

2. A method as described in claim 1, wherein the content is an advertisement.

3. A method as described in claim 1, wherein the content selected from the group consisting of:
a video on demand (VOD);
an application;
audio content; and
a game.

4. A method as described in claim 1, wherein the auctioning is provided as a highest-bidder auction or a Dutch-type auction

5. A method as described in claim 1, wherein the auctioning is performed by a head end to the plurality of potential purchasers over a network.

6. A method as described in claim 1, wherein the content is for output by the client.

7. A method as described in claim 1, wherein the auctioning and the processing are performed at a head end that is configured to stream additional content to the client.

8. A method as described in claim 1, wherein the storage space is configured to provide digital video recorder functionality at the client.

9. A method as described in claim 1, wherein the client is configured as a device selected from the group consisting of:
a digital video recorder;
a broadcast-enabled computer;
a game console;
an information appliance; and
a wireless phone.

10. A method as described in claim 1, further comprising causing the content to be stored in the storage space on the client.

11. A method as described in claim 1, further comprising:
receiving an unexpected content item for streaming to the plurality of client devices; and
offering, for purchase, an opportunity to output said stored content in conjunction with the unexpected content item by the plurality of client devices.

12. A method as described in claim 11, wherein the offering is configured as an auction.

13. One or more computer-readable media comprising computer-executable instructions that, when executed, perform the method as recited in claim 1.

14. A method comprising:
receiving an unexpected content item for streaming to a plurality of client devices;
offering, for purchase, an opportunity to output additional content in conjunction with the unexpected content item by the plurality of client devices, wherein:
each said client includes locally-stored copies of the additional content; and
the opportunity is offered to a plurality of potential purchasers over a network.

15. A method as described in claim 14, the receiving and the offering are performed at a head end that is configured for being communicatively coupled to the plurality of client devices via a network.

16. A method as described in claim 14, wherein the offering is performed via an auction.

17. A method as described in claim 14, wherein at least one said client includes storage space that is configured to provide digital video recorder functionality.

18. A method as described in claim 14, wherein one or more said client devices are configured as a device selected from the group consisting of:
a digital video recorder;
a broadcast-enabled computer;
a game console;
an information appliance; and
a wireless phone.

19. A method as described in claim 14, further comprising processing purchasing information received from the plurality of potential purchasers to determine which said potential purchaser, if any, obtains the opportunity to have said additional content output by the plurality of client devices.

20. A method as described in claim 14, further comprising:
processing purchasing information received from the plurality of potential purchasers to determine which said potential purchaser, if any, obtains the opportunity to have said additional content output by the plurality of client devices, wherein said additional content includes an advertisement; and
when the opportunity is obtained, causing output of said additional content by each of the plurality of client devices.

21. A method as described in claim 14, further comprising:
exposing storage space on the plurality of client devices as available for purchase to the plurality of potential purchasers; and
processing purchasing information received from the plurality of potential purchasers to determine which said potential purchaser, if any, is permitted to store said additional content in the storage space on each said client.

22. A method as described in claim 21, wherein the exposing is configured as an auction.

23. One or more computer-readable media comprising computer-executable instructions that, when executed, perform the method as recited in claim 14.

24. A method comprising:
offering an opportunity to output an advertisement in response to an occurrence of an unexpected event in relation to a content item; and
substituting an advertisement obtained from a purchaser of the opportunity for a previous advertisement obtained from a previous purchaser.

25. A method as described in claim 24, wherein the offering is configured as an auction.

26. A method as described in claim 24, wherein the previous advertisement was for output in conjunction with the output of the content item.

27. One or more computer-readable media comprising computer-executable instructions that, when executed, perform the method as recited in claim 24.

28. One or more computer readable media comprising computer executable instructions that, when executed on a computer direct the computer to auction:
storage of advertisements on each of a plurality of client devices; and
an opportunity to output the stored advertisements by each of the plurality of client devices.

29. One or more computer readable media as described in claim 28, wherein the auction is provided to a plurality of potential purchasers over a network.

30. One or more computer readable media as described in claim 28, wherein the auction of the opportunity is performed in response to receipt of an unexpected content item.

31. One or more computer readable media as described in claim 30, wherein the unexpected content item includes television content.

32. One or more computer readable media as described in claim 28, wherein one or more said client devices include digital video recorder functionality.

33. A head end comprising:
a network transmitter for providing a communicative coupling to a plurality of client devices; and
one or more modules that are executable to auction storage space on each of the plurality of client devices for storing content.

34. A head end as described in claim 33, wherein each said offer is made to a plurality of potential purchasers via the network.

35. A head end as described in claim 33, wherein the storage space is configured to provide digital video recorder functionality at one or more said client devices.

36. A head end as described in claim 33, wherein one or more said client devices are configured as a device selected from the group consisting of:
a digital video recorder;
a broadcast-enabled computer;
a game console;
an information appliance; and
a wireless phone.

37. A head end as described in claim 33, wherein the one or more modules are further executable to processing purchasing information received from a plurality of potential purchasers to determine which said potential purchaser, if any, is permitted to store said content in storage space on each of the plurality of client devices.

38. A head end as described in claim 33, wherein the one or more modules are further executable to process purchasing information received from a plurality of potential purchasers to determine which said potential purchaser, if any, obtains the opportunity to have said content output by the plurality of client devices.

39. A head end as described in claim 33, wherein the one or more modules are further executable to cause an output of said content by at least one said client.

40. A head end as described in claim 33, further comprising a processor and memory that is configured to store the one or more modules, wherein the one or more modules are executable on the processor.

41. A client comprising:
a processor;
a network connection device; and
memory configured to maintain:
an advertisement; and
one or more modules that are executable on the processor to output the advertisement in response to a broadcast of an unexpected television program that is received via the network connection device.

42. A client as described in claim 41, wherein the memory is configured to provide digital video recorder functionality.

43. A client as described in claim 41, wherein the advertisement is received as a result of an auction provided by the head end to a plurality of potential purchasers via a network.

44. A client as described in claim 41, wherein the television program is unexpected such that it is not previously scheduled for output.
